(19) United States
(12) Patent Application Publication
(10) Pub. No.: US 2026/0322589 A1
(43) Pub. Date: Oct. 15, 2026

(54) DISTRIBUTED CODE SCHEMES FOR DEVICE SECURITY

(71) Applicant: Taiwan Semiconductor Manufacturing Company, Ltd., Hsinchu (TW)

(72) Inventors: Mincent Lee, New Taipei City 242 (TW); Chun-Hao Chang, Hsinchu (TW); Chia-En Huang, Taipei City (TW)

(73) Assignee: Taiwan Semiconductor Manufacturing Company, Ltd., Hsinchu (TW)

(21) Appl. No.: 19/174,012

(22) Filed: Apr. 9, 2025

(51) Int. Cl. H04L 9/08; H04L 9/32

(52) U.S. Cl. CPC H04L 9/0825; H04L 9/3247

(57) ABSTRACT

Memory devices, circuits, and a method of operating the same are disclosed. In one aspect, a computing device includes a plurality of memory devices and a memory controller. The memory controller includes an encrypted memory map. The memory controller can decrypt the encrypted memory map to generate a decrypted memory map that defines memory locations of a plurality of code regions of the memory devices. The memory controller can retrieve microcode and a protection key using the memory locations of the code regions. The memory controller can validate the microcode and the protection key and execute the microcode using the protection key.

### BACKGROUND

The semiconductor industry has experienced rapid growth due to continuous improvements in the integration density of a variety of electronic components (e.g., transistors, diodes, resistors, capacitors, etc.). For the most part, this improvement in integration density has come from repeated reductions in minimum feature size, which allows more components to be integrated into a given area.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a diagram of an example system implementing the distributed code scheme techniques described herein, in accordance with some embodiments.

FIG. 2 illustrates a diagram of an example system-on-chip (SoC) device implementing the distributed code scheme techniques described herein, in accordance with some embodiments.

FIG. 3 illustrates a diagram of an example system including additional memory configurations implementing the distributed code scheme techniques described herein, in accordance with some embodiments.

FIG. 4 illustrates a flowchart of an example method for initializing a computing system implementing the distributed code scheme techniques described herein, in accordance with some embodiments.

FIG. 5 illustrates a flowchart of an example method 500 of renewing microcode and protection key(s), in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The systems and methods described herein relate to implementing microcode-based safety controls for high-performance computing systems. High-performance computing systems often require robust safety controls to prevent unauthorized access and ensure secure operation. These systems typically involve complex architectures that can be vulnerable to security breaches if not properly protected. Conventional computing devices may lack sufficient safety controls, making them susceptible to attacks or unauthorized modifications. As such, there exists a need for robust safety mechanisms that can protect these systems from potential threats. Other approaches to securing high-performance computing systems often fall short in providing adequate protection against sophisticated attacks. Specifically, traditional security measures rely on static protection mechanisms that can be overcome using brute-force techniques.

The techniques described herein address these challenges by implementing microcode-based safety controls that provide protection for various computing systems. The techniques described herein use secure microcode using a protection key having a large number of bits (e.g., greater than sixty-four thousand bits, etc.). The microcode and protection key can be regularly updated, either periodically or on demand, to protect against brute-force techniques that may otherwise be applied to static protection codes.

The microcode and protection key can be refreshed according to predefined life cycles, and may be renewed based on communications from one or more external computing systems. For example, a subscription mode can be implemented, in which a computing device receives periodically updated pairs of microcode and protection keys. In some implementations, the life cycle of the protection key can be encrypted via the microcode or protection key, and the renewal process can involve connecting to a network to obtain updated microcode and protection key pair.

Various approaches may be used to store the microcode and protection key. In some implementations, the microcode and protection key are stored in a virtual non-volatile memory (NVM) array, which may be implemented using one-time programmable (OTP), multi-time programmable (MTP), magneto-resistive random-access memory (MRAM), or resistive random-access memory (RRAM) technologies, among others. The new microcode and protection key can be randomly distributed across various storage elements of the memory device to increase the security of the system.

For example, the protection key and/or portions of the microcode may be distributed across multiple memory modules of a virtual NVM array, with storage locations selected based on a random seed. The memory map of the distributed code blocks can be encrypted using the random seed, and the encryption can be decrypted using a key generated using an internal memory redundancy configuration circuit. In some implementations, usage of the protection key and microcode can be tracked using a memory controller, which can read and update a counter to manage the distribution and encryption of the microcode and protection key.

The techniques described herein can be implement any type of computing device, system, or circuit. In some implementations, the techniques described herein can be implemented as a system-on-chip (SoC) that includes multiple memory circuits and a network circuit. In some implementations, the techniques described herein can be implemented as a chip-on-wafer-on-substrate (CoWoS) with memory stacks or hierarchical memory groups. In some implementations, the memory stacks can be high-bandwidth memory (HBM) for high-performance applications.

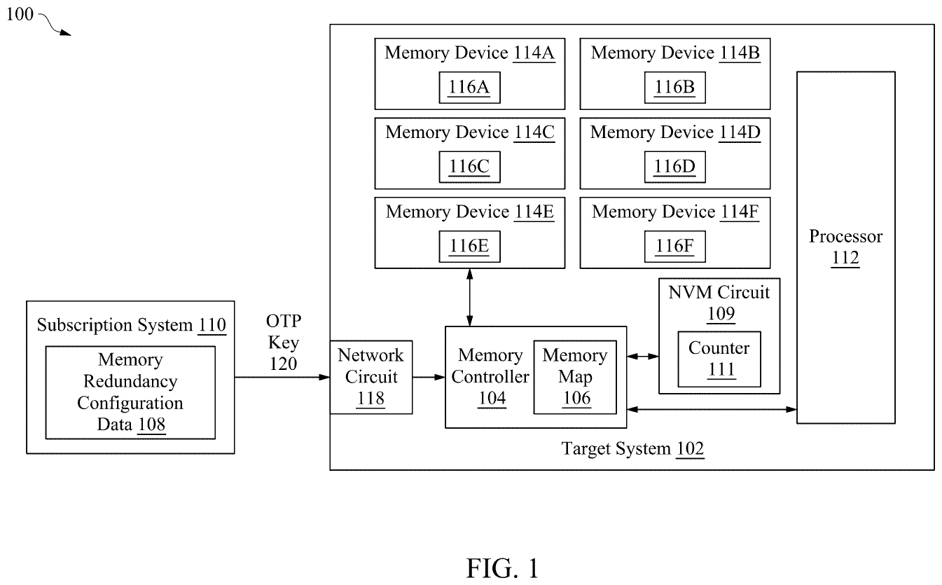

FIG. 1 illustrates a diagram of a system 100 implementing the distributed code scheme techniques described herein, in accordance with some embodiments. The system 100 is shown as including a target system 102 and a subscription system 110. The target system 102 is shown as including a memory controller 104, an NVM circuit 109, at least one processor 112, one or more memory devices 114A-114F, and a network circuit 118. The memory controller 104 is shown as including a memory map 106. The NVM circuit 109 is shown as including a counter 111. The memory devices 114A-114F are shown as including one or more code regions 116A-116F. The subscription system 110 is shown as including memory redundancy configuration data 108. The memory redundancy configuration data 108 can be used to provide an OTP key 120, as described in further detail herein.

Each of the components shown in the system 100 may receive power from one or more voltage sources. The components of the system 100 may include one or more circuits, one or more logic gates, and/or sub-circuits, each of which may be constructed from one or more logic gates. Logic gates are electronic devices that perform logical operations on one or more input signals to produce a single output signal. Various embodiments of the circuits and logic gates that implement the components of the system 100 may include various transistors. The transistors described herein may have a certain type (n-type or p-type), but embodiments are not limited thereto. The transistors can be any suitable type of transistor including, but not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like.

Each of the target system 102 and the subscription system 110 can be any type of computing device, computing system, or component thereof. Each of the target system 102 and the subscription system 110 may include a microprocessor, an application-specific integrated circuit (ASIC), a field-programmable gate array (FPGA), a graphics processing unit (GPU), a tensor processing unit (TPU), etc., or combinations thereof. In some implementations, one or more of the target system 102 and the subscription system 110 may be included as part of a cloud computing system or another type of distributed computing system. In some implementations, the subscription system 110 and the target system 102 may communicate via one or more computer networks. In some implementations, the target system 102 can be an accelerator for a variety of mathematical operations, including operations involving parallel processing, machine learning, or artificial intelligence, such as matrix multiplication, convolution, or neural network processing operations. In some implementations, the target system 102 may be implemented as part of any suitable processing device. The target system 102 can be used for different types of applications, such as artificial intelligence systems, scientific simulations, data analytics, or computer vision, among others.

The target system 102 is shown as including a memory controller 104. The memory controller 104 can be any type of circuit that manages the accessing or modifying data stored in the memory devices 114A-114F of the target system 102. For example, the memory controller 104 can coordinate the read and write operations to and from the memory devices 114A-114F, which may be initiated by the processor 112 or the NVM circuit 109, as described in further detail herein. In some implementations, the memory controller 104 can include error detection and correction mechanisms to maintain data accuracy. The memory controller 104 can include the memory map 106, which can store the locations of the code regions 116A-116F within the memory devices 114A-114F.

The processor 112 can be any type of processor, including a general-purpose processor, a specialized processor, or a combination thereof. In some implementations, the microcode can execute at the processor 112 during the various techniques described herein, enabling the processor 112 to perform specific tasks or operations as defined by the microcode. Generally, the processor 112 can execute instructions, perform calculations, and manage data flow within the target system 102. In some implementations, the processor 112 can include multiple processing devices. For example, the processor 112 may include multiple processing devices that can perform artificial intelligence (AI) operations, such as neural network inference, machine learning model training, or data analysis, among others. In some implementations, the processor 112 can be used to perform or facilitate any of the operations (e.g., verification, decryption/encryption, etc.) described herein.

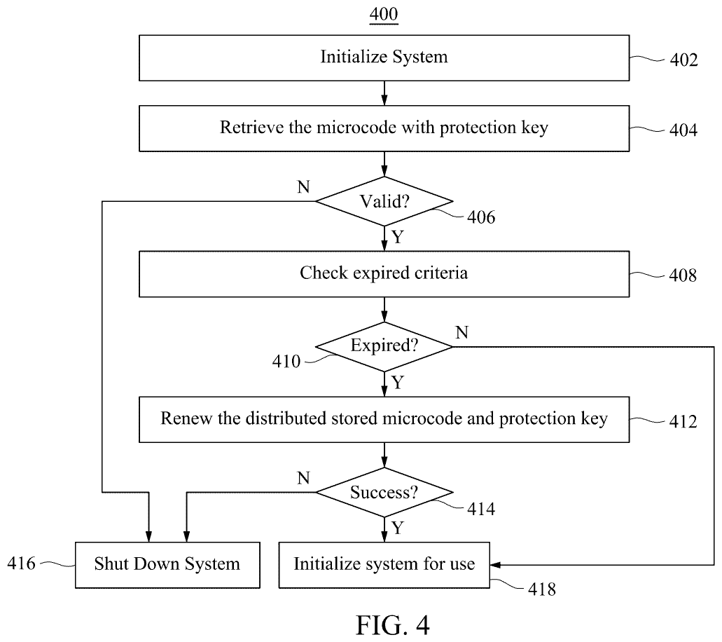

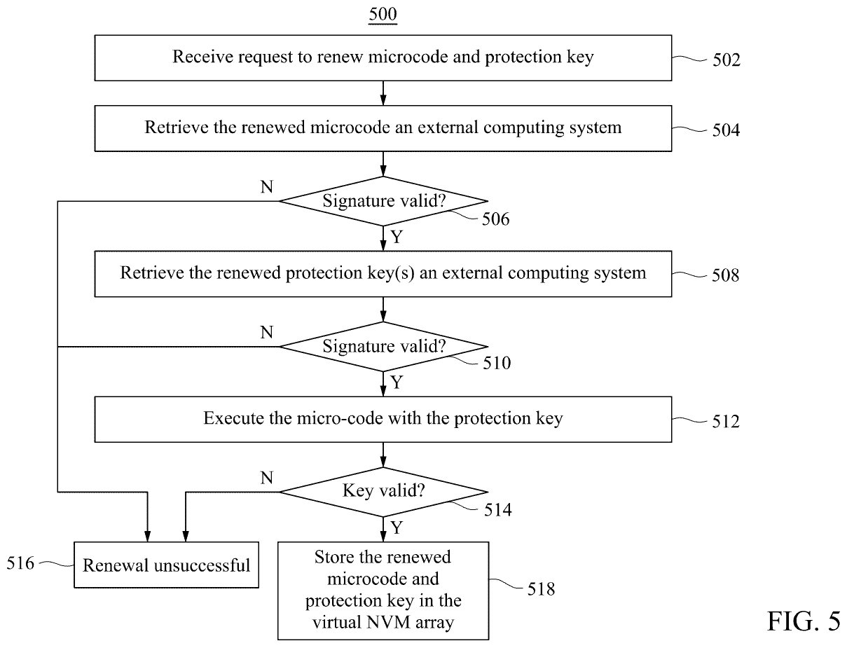

The memory controller 104 can interact with the NVM circuit 109 to manage the storage and retrieval of data in the code regions 116A-116F. In some implementations, the memory controller 104 may initiate retrieval and execution of microcode using the protection key stored in the code regions 116A-116F by communicating with the NVM circuit 109. In some implementations, the memory controller 104 can also perform encryption and decryption of any microcode and/or protection keys. The memory controller 104, via communications with the NVM circuit 109, can perform any of the operations described in connection with the method 400 of FIG. 4 or the method 500 of FIG. 5 to initiate the target system 102 using stored protection keys or renew protection keys and/or microcode. For example, in response to receiving updated microcode and protection key pairs from the subscription system 110 via the network circuit 118, the memory controller 104 can distribute corresponding data across the memory devices 114A-114F, as described in further detail herein.

The target system 102 is shown as including an NVM circuit 109. The NVM circuit 109 can be any type of non-volatile memory circuit that retains stored data even when not powered. The NVM circuit 109 can utilize various non-volatile memory circuits, such as OTP memory circuits, MTP memory circuits, MRAM circuits, or RRAM circuits, among others. In some implementations, the NVM circuit 109 can include multiple memory circuits, which may be or include different types of non-volatile memory. In some implementations, the NVM circuit 109 can communicate with the memory controller 104 via a corresponding memory bus. In some implementations, the memory bus via which the NVM circuit 109 can communicate with the memory controller 104 may be a different memory bus than the memory bus(es) used by the memory controller 104 to communicate with the memory devices 114A-114F or the processor 112. In some implementations, the memory bus via which the NVM circuit 109 can communicate with the memory controller 104 may be the same memory bus as the memory bus(es) used by the memory controller 104 to communicate with the memory devices 114A-114F or the processor 112.

The NVM circuit 109 can be a controller for various non-volatile memory devices (e.g., the memory devices 114A-114F) of the target system 102. The NVM circuit 109 can manage the storage, retrieval, and modification of data within these memory devices, ensuring data integrity and efficient access. In some implementations, the NVM circuit 109 can include error detection and correction mechanisms to maintain data accuracy. The NVM circuit 109 can store a memory redundancy configuration for the memory devices 114A-114F, which can include information about redundant memory elements and their usage to enhance data reliability and fault tolerance.

The NVM circuit 109 can be configured with a random seed value, which can be stored using one-time programmable memory elements or other suitable technologies. This random seed value can be used by the memory controller 104 to encrypt the memory map 106, ensuring that the locations of the code regions 116A-116F within the memory devices 114A-114F remain secure. The NVM circuit 109 can communicate with other components of the target system 102, such as the memory controller 104, to coordinate the storage and retrieval of data. In some implementations, the NVM circuit 109 can also interact with the processor 112 and the network circuit 118 to manage the distribution and encryption of the microcode and protection key, as described in further detail herein.

The NVM circuit 109 is shown as including a counter 111. The counter 111 can be any type of logic element or circuit that can track the usage of the microcode and protection key within the NVM circuit 109. In some implementations, the counter 111 can include one or more counter registers, which can store numerical values representing the number of times the microcode and protection key have been accessed. In some implementations, the counter 111 can track the number of times the target system 102 has booted and/or initialized. In some implementations, the counter 111 can be implemented using flip-flops, latches, or other logic elements. The counter 111 can be configured to increment, for example, upon receiving a signal from the memory controller 104 or another component of the target system 102 that can detect when the target system 102 is initialized or reset.

In some implementations, the counter 111 can be updated by the memory controller 104 to track the usage of the microcode and protection key. In some implementations, the memory controller 104 can read the current value of the counter 111 and increment it each time the microcode or protection key is accessed. The counter 111 may be reset (e.g., by the memory controller 104, another component, etc.) when new microcode and protection key pairs are received from the subscription system 110 or when the microcode and protection key are redistributed among the memory devices 114A-114F. Resetting the counter can ensure that the counter 111 accurately reflects the current usage of the microcode and protection key in correspondence with their distribution across the memory devices 114A-114F.

The target system 102 is shown as including one or more memory devices 114A-114F. The memory devices 114A-114F can be any type of non-volatile memory, such as OTP memory, MTP memory, MRAM, flash memory, or RRAM, among others. The memory devices 114A-114F can interact with the target system 102, for example, by providing the target system 102 with input data to be processed, or by storing the results of computations performed by the target system 102 via the processor 112. The memory devices 114A-114F can store different types of data, such as program instructions, program data, or any other data described herein. In this example, the memory devices 114A-114F can be implemented as a memory array. Although six memory devices 114A-114F are shown, it should be understood that any number or configuration of memory devices 114A-114F may be implemented as part of the target system 102. In some implementations, the memory devices 114A-114F may include volatile memory, such as static random access memory (SRAM) or dynamic random access memory (DRAM), among others.

One or more of the memory devices 114A-114F can store microcode, protection keys, or other information described herein in the code regions 116A-116F. The code regions 116A-116F can be specific areas within the memory devices 114A-114F designated for storing microcode and protection keys. The code regions 116A-116F regions can be structured to optimize data retrieval and storage efficiency, for example, by being defined as a contiguous region of memory within a corresponding memory device. In some implementations, each code regions 116A-116F can store a portion of the microcode, protection key, or other data. The memory locations of the code regions 116A-116F can be randomly selected among two or more of the memory devices 114A-114F, such that the microcode and protection keys are stored in a secure and distributed manner.

In some implementations, the size of the code regions 116A-116F can range from eight to sixteen thousand bits. The total code capacity of the code regions 116A-116F can be calculated as the product of the number of code regions 116A-116F and the size of each of the code regions 116A-116F. In some implementations, each of the code regions 116A-116F can vary in size, in which case the total code capacity of the code regions 116A-116F can be calculated as a sum of their respective sizes. In some implementations, the data stored in each of the code regions 116A-116F may not occupy the entirety of the bits dedicated to those code regions 116A-116F. In such cases, padding bits (e.g., predetermined bits or patterns of bits) can be added. Information relating to the specific arrangement (e.g., size, padding data, etc.) of the code regions 116A-116F can be stored within a corresponding memory map 106, as described herein.

In some implementations, the data (e.g., microcode, protection key(s), dummy data, padding data, etc.) stored in the code regions 116A-116F can be encrypted using a random seed value stored or otherwise maintained as part of the NVM circuit 109, as described in further detail herein. The locations of each of the code regions 116A-116F can be provided and encrypted in the memory map 106. The memory controller 104 can coordinate the retrieval and distribution of microcode, protection keys, and other data within the code regions 116A-116F across the memory devices 114A-114F. Although each memory device 114A-114F is shown as including a respective code region 116A-116F, it should be understood that the code regions 116A-116F may not necessarily be distributed on a one-to-one basis across the memory devices 114A-114F. For example, in some implementations, one of the memory devices 114A-114F may include two or more of the code regions 116A-116F. In another example, one of the memory devices 114A-114F may include none of the code regions 116A-116F.

The memory controller 104 is shown as including a memory map 106. The memory map 106 can be a data structure that stores the memory locations of the code regions 116A-116F distributed across the memory devices 114A-114F. For example, the memory map 106 can include memory pointers and/or size values indicating the location and size of each of the code regions 116A-116F. In some implementations, the memory map 106 may specify the order or arrangement that the data of the code regions 116A-116F is to be combined. In some implementations, the memory map 106 can store information indicating an amount of padding data or the type of data stored in each of the code regions 116A-116F. In some implementations, the memory map 106 can be organized as a table or a list, with entries corresponding to the addresses of the code regions 116A-116F within the memory devices 114A-114F and any associated information.

The memory map 106 can be encrypted using a random seed value stored in configuration data (e.g., memory redundancy configuration data) of the NVM circuit 109. Encrypting the memory map 106 can prevent unauthorized access to the locations of the code regions 116A-116F. The random seed value can be used to generate an encryption key, which can then be applied to the memory map 106 to encrypt its contents. The encrypted memory map 106 can be stored within the memory controller 104, as shown. Any suitable form of encryption may be used to encrypt the memory map 106, as described in further detail herein. In some implementations, the memory map may be unencrypted, but the contents of the code region 116A-116F may be encrypted using the random seed and similar encryption techniques.

In some implementations, the memory controller 104 can update and encrypt the memory map 106 when renewing or redistributing data among the code regions 116A-116F. This process can involve generating a new encryption key from the seed value of the NVM circuit 109, encrypting the updated memory map 106 with the new encryption key, and storing the encrypted memory map 106 within the memory controller 104. The memory map 106 can be decrypted (e.g., by the memory controller 104) using an OTP key 120 provided by the subscription system 110. The OTP key 120 can serve as a public key that enables the memory controller 104 to decrypt access the locations of the code regions 116A-116F. In some implementations, a copy of the OTP key 120 may be stored in one or more memory elements of the memory controller 104 and/or in the NVM circuit 109.

The target system 102 is shown as including a network circuit 118. The network circuit 118 can be any type of circuit that manages network communications for the target system 102. The network circuit 118 can perform operations such as establishing and maintaining network connections, transmitting, and receiving data packets, and ensuring secure communication between the target system 102 and external systems, such as the subscription system 110. In some implementations, the network circuit 118 can support various communication protocols, such as Ethernet, Wi-Fi, or other suitable protocols, to facilitate data exchange. The network circuit 118 can also include encryption and decryption components to automatically establish and communicate using secure, encrypted communication channels, such as those implementing the Transport Layer Security (TLS) or Secure Sockets Layer (SSL) cryptographic protocols.

The network circuit 118 can facilitate communication between the target system 102 and external systems, including the subscription system 110. Communication with the external systems can be performed to renew or retrieve updated microcode and corresponding protection keys. The network circuit 118 can connect to a network to obtain updates from the subscription system 110, ensuring that the target system 102 receives the latest microcode and protection key pairs. In some implementations, the network circuit 118 can establish a secure connection with the subscription system 110 via one or more application programing interface (API) endpoints and/or predetermined file locations (e.g., a predetermined uniform resource locator (URL), etc.) to download or otherwise access the updated microcode and protection key pairs. The network circuit 118 can then transmit the updates to the memory controller 104, which can distribute the new code blocks across the memory devices 114A-114F, as described in further detail herein.

The system 100 is shown as including a subscription system 110. The subscription system 110 is shown as including memory redundancy configuration data 108 corresponding to the memory redundancy configuration data of the NVM circuit 109 of the target system 102. The memory redundancy configuration data 108 can be include information that can be used to generate corresponding public keys capable of decrypting data that is encrypted using the random seed of the NVM circuit 109. In some implementations, the memory redundancy configuration data 108 may be generated during programming of the NVM circuit 109, for example, when the NVM circuit 109 is initially manufactured or configured. The memory redundancy configuration data 108 can be used by the subscription system 110 to generate the OTP key 120. The subscription system 110 can generate the OTP key 120 by applying cryptographic algorithms to the memory redundancy configuration data 108, such that the OTP key 120 operates as a public decryption key for data encrypted using the random seed of the NVM circuit 109.

The subscription system 110 can store or otherwise maintain up-to-date microcode and corresponding protection keys. For example, the subscription system 110 can receive or retrieve microcode (and in some implementations, corresponding protection keys) from various data sources or via an operator of the subscription system 110. In some implementations, the subscription system 110 can generate protection keys for the microcode using various cryptographic approaches. For example, the subscription system 110 can use key derivation functions to generate protection keys based on a master key or a random seed value. In some implementations, the microcode may include or may be encoded using a digital signature that can be decoded or verified using the corresponding protection key(s).

In some implementations, the subscription system 110 can generate the digital signature(s) for the microcode by applying a cryptographic algorithm using a protection key. The protection key may have greater than sixty-four thousand bits, in some implementations. The digital signature can be a unique cryptographic hash that represents the microcode, such that any alteration to the microcode would result in a different hash value. In some implementations, the protection key used to generate the digital signature can be derived from the memory redundancy configuration data 108, or another seed value. The digital signature can be included as part of or transmitted with the microcode as part of the renewal process described herein.

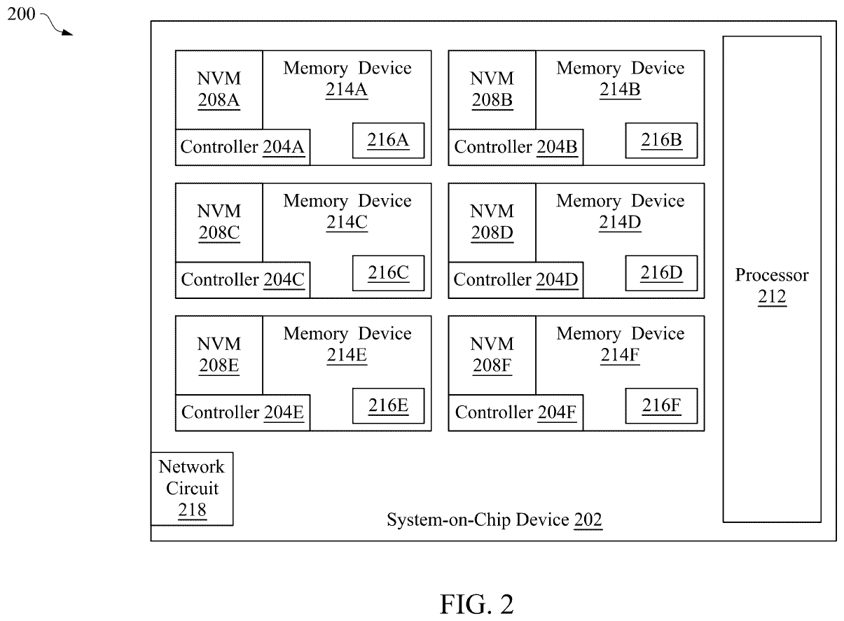

Referring to FIG. 2, illustrated is a diagram of an example system 200 implementing the distributed code scheme techniques described herein, in accordance with some embodiments. The system 200 is shown as including an SoC device 202. The SoC device 202 is shown as including at least one processor 212, a network circuit 218, and one or more memory devices 214A-214F each having corresponding memory controllers 204A-204F and corresponding NVM circuits 208A-208F. Although not shown here, in some implementations, the system 200 may include a subscription system, such as the subscription system 110 described in connection with FIG. 1.

Each of the components shown in the system 200 may receive power from one or more voltage sources. The components shown in the system 200 may include one or more logic gates and sub-circuits, each of which may be constructed from one or more logic gates. Logic gates are electronic devices that perform logical operations on one or more input signals to produce a single output signal. Various embodiments of the circuits and logic gates that implement the components shown in the system 200 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like.

Each of the components of the system 200 can be similar to, and perform any of the structure or functionality of, the corresponding component described in connection with FIG. 1. The processor 212 can be similar to, and perform any of the structure or functionality of, the processor 112 of FIG. 1. The network circuit 218 can be similar to, and perform any of the structure or functionality of, the network circuit 118 of FIG. 1. The memory devices 214A-214F can be similar to, and perform any of the structure or functionality of, the memory devices 114A-114F of FIG. 1. Each of the memory controllers 204A-204F can be similar to, and perform any of the structure or functionality of, the memory controller 104 of FIG. 1. Each of the NVM circuits 208A-208F can be similar to, and perform any of the structure or functionality of, the NVM circuit 109 of FIG. 1. Although six memory devices 214A-214F (which corresponding memory controllers (204A-204F) are shown, it should be understood that any number or configuration of memory devices 114A-114F may be implemented as part of the target system 102.

In this example, the SoC device 202 can be similar to the target system 102 of FIG. 1, but with some differences in its configuration. In this example, instead of having a single memory controller 104, the SoC device 202 includes multiple memory controllers 204A-204F and corresponding NVM circuits 208A-208F. This configuration can enable the SoC device 202 to efficiently handle data storage and retrieval across multiple memory devices 214A-214F, which may include different memory dies, memory banks, or discrete circuits. Each memory controller 204A-204F can manage its respective memory device 214A-214F using approaches similar to those described in connection with FIG. 1.

In some implementations, different memory devices 214A-214F of the SoC device 202 may be different memory dies. For example, each memory device 214A-214F can be a separate physical memory chip provided with the package of the SoC device 202. In some implementations, a single microcode and protection key may be used for accessing the functionality of the SoC device 202 (e.g., one or more dies of the SoC device 202), distributed among multiple memory devices 214A-214F. For example, multiple dies may include or use microcode to function. During device initialization, the microcode can be retrieved and verified using one or more of the memory controllers 204A-204F, and provided to or otherwise executed by their corresponding dies.

In some implementations, multiple sets of microcode and corresponding protection keys may be used for accessing different dies of the SoC device 202. For example, each memory die can have its own set of microcode and protection keys, providing additional security and flexibility. In some implementations, multiple sets of microcode can be distributed among a single corresponding memory device 214A-214F or across multiple memory devices 214A-214F. This distribution can be managed by the memory controllers 204A-204F, which can coordinate the storage and retrieval of the microcode and protection keys, according to the techniques described herein. One or more of the memory controllers 204A-204F may coordinate decoding or encrypting/distributing microcode among the multiple memory devices 214A-214F.

The network circuit 218 can receive and provide similar OTP keys to the memory controllers 204A-204F of the corresponding memory devices 214A-214F. Receiving OTP keys (e.g., OTP key 120) may include providing a respective OTP key to each of the memory controllers 204A-204F to decode a corresponding memory map that stores memory locations of the code regions 216A-216F (e.g., similar to the code regions 116A-116F of FIG. 1). For example, the network circuit 218 receives OTP keys from an external subscription system, similar to the subscription system 110 of FIG. 1. The network circuit 218 can then distribute the OTP keys to the memory controllers 204A-204F. In some implementations, the memory map(s) may be stored in one or a subset of the memory controllers 204A-204F. The various components of the SoC device 202 can communicate with one another to distribute OTP keys, memory map information, or microcode with corresponding protection keys via one or more communication buses.

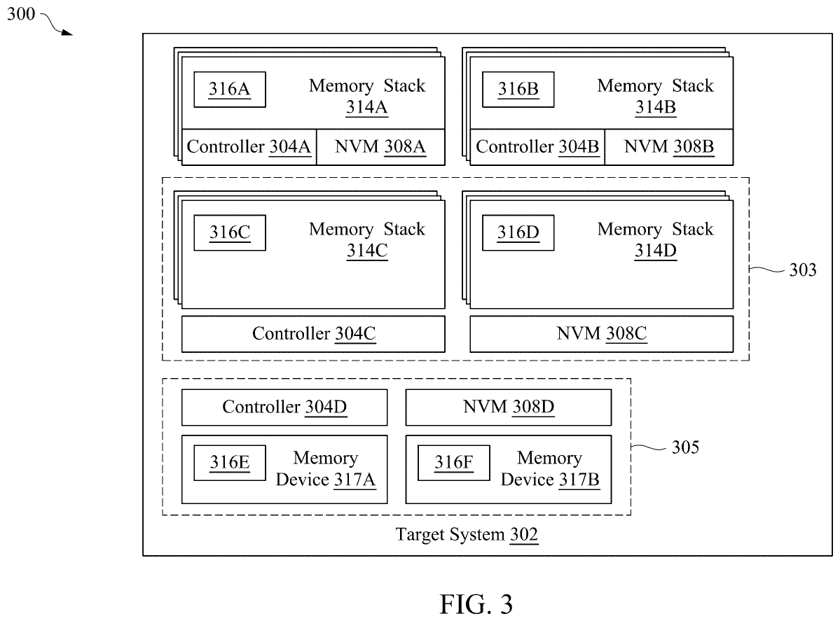

FIG. 3 illustrates a diagram of an example system 300 comprising a target system 302 including additional memory configurations implementing the distributed code scheme techniques described herein, in accordance with some embodiments. The target system 302 is shown as including one or more controllers 304A-304D, one or more NVM circuits 308A-308D, one or more memory stacks 314A-314D, and one or more code regions 316A-316F. The target system 302 can be similar to the target system 102 of FIG. 1, including various alternative memory configurations. In some implementations, the components of the target system 302 can be defined as a CoWoS, in which one or more components are defined as chips that are stacked onto a wafer, which is then integrated onto a substrate. In some implementations, the one or more memory stacks 314A-314D may be stacks of high bandwidth memory (HBM) devices. Each of the memory stacks 314A-314D can include respective memory controllers 304A-304D and corresponding NVM circuits 308A-308D, providing enhanced data management and redundancy.

The target system 302 includes memory dies of varying configurations. It should be understood that the examples of different memory combinations are not exhaustive, and additional memory configurations can be added, removed, or included in parallel to achieve useful results. In this example, each of the memory stacks 314A and 314B can be respective memory dies, respectively including the memory controller 304A and the NVM circuit 308A, and the memory controller 304B and the NVM circuit 308B. In such implementations, each memory die can perform the various techniques of the memory controller 104 and NVM circuit 109 to secure microcode and protection keys within the code regions 316A-316B of their respective memory stack 314A or 314B. Although only one code region 316A-316B is shown for the memory stacks 314A or 314B, it should be understood that any memory device described herein may include any number of code regions 316A-316F to store various code data. In some implementations, the memory stacks 314A and 314B may distributed shared code data between one another, as described in one example configuration of the SoC device 202 of FIG. 2.

The target system 302 is shown as including one of the memory stacks 314C and 314D defined on a first shared memory die 303. The first shared memory die 303 is shown as including the memory controller 304C and the NVM circuit 308C, both serving the memory stacks 314C and 314D, for example, by storing microcode and protection keys among the code regions 316C and 316D. In some implementations, each memory controller 304A-304C can manage their corresponding respective memory stacks 314A-314D. The memory stacks 314A-314D can be stacks of memory devices (e.g., stacks of memory devices 114A-114F, stacks of memory devices 214A-214F, etc.).

In another similar memory configuration, each of the memory devices 317A and 317B (which may be similar to the memory devices 114A-114F of FIG. 1 or the memory devices 214A-214F of FIG. 2) are shown as being defined on the second shared memory die 305, which includes the memory controller 304D and the NVM circuit 308D. In this example, the memory controller 304D and the NVM circuit 308D serve the memory devices 317A and 317B, for example, by storing microcode, protection keys, or other information within corresponding code regions 316E-316F. Although not shown in this example, in some implementations the target system 302 may include one or more network circuits (e.g., the network circuit 118 of FIG. 1, the network circuit 218 of FIG. 2), to receive and process OTP keys from one or more external computing systems (e.g., the subscription system 110, etc.). In some implementations, a network circuit may not be included, and the memory controllers 304A-304D can manage encryption, decryption, and redistribution of microcode, protection keys, and/or additional data within the code regions 316A-316F according to the techniques described herein.

FIG. 4 illustrates a flowchart of an example method 400 for initializing a computing system implementing the distributed code scheme techniques described herein, in accordance with some embodiments. The method 400 may be performed by one or more components of a computing system (e.g., the target system 102 of FIG. 1, the SoC device 202 of FIG. 2, the target system 302 of FIG. 3, etc.). It is noted that the method 400 is merely an example and is not intended to limit the present disclosure. Accordingly, it is understood that additional operations may be provided before, during, and after the method 400 of FIG. 4, and that some other operations may only be briefly described herein.

In brief overview, the method 400 starts with operation 402, which includes initializing a computing system (e.g., the target system 102, etc.). The method 400 proceeds to operation 404, which includes retrieving the microcode with a protection key. The method 400 proceeds to operation 406, which includes determining whether the microcode and protection key are valid. If the microcode and protection key are valid, the method 400 proceeds to operation 408, which includes retrieving one or more expiration criteria for the microcode and protection key. If the microcode and protection key are not valid, the method 400 proceeds to operation 416, which includes shutting down the computing system. From operation 408, the method 400 proceeds to operation 410, which includes determining whether the protection key and microcode are expired. If the microcode and protection key are not expired, the method 400 proceeds to operation 418, which includes initializing the computing system for use. If the microcode and protection key are expired, the method 400 proceeds to operation 412, which includes renewing the microcode and protection key. From operation 412, the method 400 proceeds to operation 414, which can include determining whether the renewal operation of operation 412 was successful. If the renewal operation was successful, the method 400 proceeds to operation 418. If the renewal operations was unsuccessful, the method 400 proceeds to operation 416.

Referring to operation 402, the method 400 can include initializing a computing system (e.g., the target system 102, etc.). Initializing the computing system can involve, for example, controlling power to various components of the computing system. In some implementations, this may involve initializing clock circuits and/or communicating with various components of the computing system (e.g., using a reset or power-on management circuit) to manage system startup. During this process, a memory controller (e.g., the memory controller 104 of FIG. 1) can retrieve an encrypted memory map (e.g., the memory map 106) from an NVM circuit (e.g., the NVM circuit 109, etc.), decrypt the memory map using a suitable key (e.g., the OTP key 120), which may be stored in one or more memory elements of the memory controller (or the NVM circuit) or provided by an external computing system (e.g., the subscription system 110), and identify code regions (e.g., code regions 116A-116F, etc.) storing microcode and corresponding protection key(s) in one or more memory devices (e.g., the memory devices 114A-114F).

Referring to operation 404, the method 400 can retrieving microcode with a protection key. Once the code regions are identified, the memory controller can reconstruct the microcode and protection key (e.g., based on the arrangement specified in the memory map) from the code regions and load the microcode (e.g., into a processor 112, etc.) for execution and verification. Once the microcode is reconstructed and loaded, the computing system can begin executing the microcode with the protection key to perform various tasks and operations. The protection key can be used to decrypt and authenticate the microcode, ensuring that it has not been modified or replaced with substitute microcode.

Referring to operation 406, the method 400 can include determining whether the microcode is valid. The computing system can perform one or more validation steps to determine that the microcode is valid. The validation steps may involve calculating a cryptographic hash of the microcode and comparing it to a pre-stored hash value (e.g., the protection key), verifying the digital signature of the microcode using the protection key, or any other suitable validation step. In some implementations, multiple validation checks may be performed using the protection key. In some implementations, the microcode may be encrypted in a manner such that only the protection key can decrypt the microcode. If any of these validation steps fail, the method 400 can proceed to operation 416. If the validation step(s) are successful, the method 400 can proceed to operation 408.

Referring to operation 408, the method 400 can include retrieving one or more expiration criteria for the microcode and protection key. In some implementations, the computing system can access the one or more expiration criteria stored in an NVM circuit (e.g., the NVM circuit 109) or other components of the computing system. The one or more expiration criteria can include information about the validity period of the microcode and protection key, such as usage limit corresponding to the protection key and/or microcode. In some implementations, the one or more expiration criteria may be stored or otherwise reconstructed from data in the one or more of the code regions of the computing system. In some implementations, the one or more expiration criteria may be stored in one or more memory elements of the memory controller, the NVM circuit, or any other component of the computing system. In some implementations, the one or more expiration criteria may be received from an external computing system (e.g., the subscription system 110, etc.).

Referring to operation 410, the method 400 can include determining whether the protection key and microcode are expired based on the one or more expiration criteria. For example, the computing system can compare the number of times the computing system has used the microcode and protection key (e.g., stored as part of the counter 111, etc.) to a corresponding threshold in the one or more expiration criteria retrieved in operation 408. If the counter exceeds the threshold, the computing system can determine that the microcode and protection key has expired. In some implementations, the computing system can determine that the microcode and protection key has expired if the computing system receives an indication from one or more external computing systems that the microcode and protection key has expired. In some implementations, the one or more expiration criteria may specify a date and time (e.g., a timestamp value), after which the microcode and protection key are considered expired. In such implementations, the computing system can compare a timestamp of the current time (e.g., via one or more clock circuits, etc.) to the expiration timestamp. If the current time exceeds the expiration time, the computing system can determine that the microcode and protection key has expired. If the microcode and protection key has expired, the method 400 can proceed to operation 412. If none of the expiration criteria are satisfied, the method 400 can proceed to operation 418.

Referring to operation 412, the method 400 can include renewing the microcode and protection key. Renewing the microcode and protection key can involve performing the operations of the method 500 of FIG. 5. For example, the internal logic of the computing system (e.g., the memory controller 104, etc.) can initiate a request to renew the protection key. In some implementations, a request to renew the protection key may be received from an external computing system.

Referring to operation 414, the method 400 can include determining whether the renewal operation of operation 412 was successful. To do so, the computing system can verify that the renewal process of the method 500 of FIG. 5 was performed successfully. If the renewal operation is successful, the computing system can authorize the execution of the new microcode and protection key and proceed to operation 418. If the renewal operation fails, the method 400 can proceed to operation 416.

Referring to operation 416, the method 400 can include shutting down or deactivating the computing system. To do so, the computing system can prevent the execution of the microcode by halting any ongoing processes and unloading the microcode from memory, in some implementations. In some implementations, the computing system can send one or more error signals to various components of the computing system, indicating that microcode and/or protection key are invalid. In some implementations, the error signals can include error codes indicating which step of the method 400 failed (e.g., the reason the microcode is invalid). In some implementations, the error signals can prompt cause one or more components of the computing system to provide user feedback to indicate that the error occurred. In some implementations, the computing system can provide one or more signals to a reset or power-off circuit of the computing system, to initiate a shutdown sequence.

Referring to operation 418, the method 400 can include initializing the computing system for use. Upon determining that the microcode and protection key are valid, the computing system can load the microcode into one or more processing elements (e.g., the processor 112) of the computing system. The microcode can then be executed to perform normal system operations, enabling the computing system to carry out its intended tasks and functions. Such processing operations may include accessing the components of the computing system, performing processing operations (e.g., artificial intelligence operations), or performing network communication operations (e.g., communicating with external computing systems, etc.).

FIG. 5 illustrates a flowchart of an example method 500 of renewing microcode and protection key(s), in accordance with some embodiments. The method 500 may be performed by one or more components of a computing system (e.g., the target system 102 of FIG. 1, the SoC device 202 of FIG. 2, the target system 302 of FIG. 3, etc.). It is noted that the method 500 is merely an example and is not intended to limit the present disclosure. Accordingly, it is understood that additional operations may be provided before, during, and after the method 500 of FIG. 5, and that some other operations may only be briefly described herein.

In brief overview, the method 500 starts with operation 502, which includes receiving a request to renew microcode and corresponding protection key(s). The method 500 proceeds to operation 504, which includes retrieving the renewed microcode from an external computing system. The method 500 proceeds to operation 506, which includes determining whether a signature of the microcode is valid. If the microcode is valid, the method 500 proceeds to operation 508, which includes retrieving renewed protection key(s) from the external computing system. If the microcode is not valid, the method 500 proceeds to operation 516, which includes shutting down or deactivating the computing system. From operation 508, the method 500 proceeds to operation 510, which includes determining a signature associated with the protection is valid. If the protection key(s) is valid, the method 500 proceeds to operation 512, which includes executing the microcode with the protection key(s). If the protection key is not valid, the method 500 proceeds to operation 516. From operation 512, the method 500 proceeds to operation 514, which can include determining whether the combination of the microcode and protection key(s) are valid. If the microcode and protection keys are valid, the method 500 proceeds to operation 518. If the microcode and protection keys are not valid, the method 500 proceeds to operation 516. The method 500 includes operation 518, which includes storing the renewed microcode and protection key in a virtual NVM array (e.g., the code regions 116A-116F, etc.).

Referring to operation 502, the method 500 can include receiving a request to renew microcode and corresponding protection key(s). The request may be provided from an external computing system (e.g., the subscription system 110) or triggered by internal logic of the computing system (e.g., the memory controller 104, etc.) as described herein. For example, in some implementations the computing system can initiate the request based on predetermined criteria, such as expiration dates or usage limits of the current microcode and protection keys being expired or exceeded.

Referring to operation 504, the method 500 can include retrieving the renewed microcode from an external computing system. For example, in some implementations, the computing system can establish a secure connection with the external computing system (e.g., the subscription system 110), using a network circuit (e.g., the network circuit 118). The computing system can transmit one or more requests for renewed microcode from the external computing system. In some implementations, the request may include data corresponding to the computing system, such as memory redundancy configuration data or other data that the external computing system may use to generate or otherwise provide the microcode and protection key(s). The computing system can store the renewed microcode in a temporary memory location, such as a buffer or cache, for further processing. This retrieval process ensures that the computing system has access to the latest microcode, which can be used to maintain the security and functionality of the system.

Referring to operation 506, the method 500 can include determining whether a signature of the microcode is valid. For example, the computing system can perform a series of validation steps to ensure the integrity and authenticity of the renewed microcode. In some implementations, the validation processes can involve calculating a cryptographic hash of the microcode and comparing it to a hash value transmitted with the microcode. In some implementations, this can involve verifying the digital signature of the microcode using a public key. For example, the digital signature of the microcode can be generated by the external computing system using a cryptographic algorithm and a private key (e.g., derived from memory redundancy configuration data, other configuration data, another random seed value, etc.). This process can involve creating a cryptographic hash of the microcode and then encrypting the hash with the private key to generate the digital signature. The digital signature can be transmitted to the computing system along with the microcode.

To verify the digital signature, the computing system can decrypt the digital signature using a corresponding public key, which can be stored in a storage location (e.g., memory elements of the memory controller 104, etc.) or another secure location within the computing system. In some implementations, the public key may be stored within memory elements of the computing system during manufacture or during a one-time programming process (e.g., stored in read-only memory). The decryption process can generate the original cryptographic hash of the microcode. The computing system can calculate a new cryptographic hash of the received microcode and compare it to the decrypted hash. If the two hashes match, the microcode is considered valid and unaltered. If the signature of the microcode is valid, the method 500 can proceed to operation 508. If the signature of the microcode is not valid, the method 500 can proceed to operation 516.

Referring to operation 508, the method 500 can include retrieving renewed protection key(s) from the external computing system. Similar to the retrieval of the renewed microcode, the computing system can use a network circuit to the transmission of one or more renewed protection keys. Once the request is received, the external computing system can transmit the renewed protection keys to the computing system. In some implementations, the external computing system can generate the protection keys based on information associated with the computing system (e.g., memory redundancy configuration data, etc.). The computing system can store the renewed protection keys in a temporary memory location for further processing.

Referring to operation 510, the method 500 can include determining whether a signature associated with the protection key is valid. For example, the computing system can perform a series of validation steps to ensure the integrity and authenticity of the renewed protection key. In some implementations, the validation processes can involve calculating a cryptographic hash of the protection key and comparing it to a hash value transmitted with the protection key. In some implementations, this can involve verifying the digital signature of the protection key using a public key. For example, the digital signature of the protection key can be generated by the external computing system using a cryptographic algorithm and a private key (e.g., derived from memory redundancy configuration data, other configuration data, another random seed value, etc.). This process can involve creating a cryptographic hash of the protection key and then encrypting the hash with the private key to generate the digital signature. The digital signature can be transmitted to the computing system along with the protection key.

To verify the digital signature, the computing system can decrypt the digital signature using a corresponding public key, which can be stored in a storage location (e.g., memory elements of the memory controller 104, etc.) or another secure location within the computing system. In some implementations, the public keys corresponding to the encrypted microcode or protection keys may be transmitted to the computing system from the external computing system during a prior time period. In some implementations, the computing system can use cryptographic algorithm(s) derive the public key from information corresponding to the information used to generate the private key at the external computing system, such as the memory redundancy configuration data stored in an NVM circuit (e.g., the NVM circuit 109) of the computing system. The decryption process can generate the original cryptographic hash of the protection key. The computing system can calculate a new cryptographic hash of the received protection key and compare it to the decrypted hash. If the signature of the protection key is valid, the method 500 can proceed to operation 512. If the signature of the protection key is not valid, the method 500 can proceed to operation 516.

Referring to operation 512, the method 500 can include executing the microcode with the protection key(s). Once the renewed microcode and protection keys have been validated, the computing system can load the microcode into one or more processing elements (e.g., the processor 112) for execution with the protection key. In some implementations, the protection keys can be used to decrypt, decode, or otherwise authenticate the microcode, ensuring that it is valid and has not been tampered with or replaced with substitute microcode.

Referring to operation 514, the method 500 can include determining whether the combination of the microcode and protection key(s) are valid. For example, the computing system can perform a series of validation steps to ensure that the microcode and protection keys work together correctly. This can involve verifying that the protection keys can successfully decrypt and authenticate the microcode, ensuring that the microcode can be executed without errors, or checking for any discrepancies or issues during the execution process, among other operations. If the combination of the microcode and protection keys is valid, the method 500 can proceed to operation 518. If the combination is not valid, the method 500 can proceed to operation 516.

Referring to operation 516, the method 500 can include shutting down or deactivating the computing system. If the validation steps determine that the microcode and/or protection keys are not valid, the computing system can prevent the execution of the microcode by halting any ongoing operations and unloading the microcode from memory. In some implementations, the computing system can send one or more error signals to various components, indicating that the microcode and/or protection keys are invalid. In some implementations, the computing system can then initiate a shutdown sequence by transmitting a signal to a reset or power-off circuit. In some implementations, the computing system can provide or store one or more indications that the renewal process was unsuccessful.

Referring to operation 518, the method 500 can include storing the renewed microcode and protection key in a virtual NVM array (e.g., the code regions 116A-116F, etc.). To do so, the computing system can determine a scheme to randomly distribute the microcode and protection key(s) across one or more code regions of non-volatile memory devices (e.g., the memory devices 114A-114F) of the computing system. The random distribution can involve concatenating the protection key and microcode into a single code segment and dividing the code and the protection key into segments that can each be stored in a respective code region.

The segmented code data can be distributed among the code regions in various ways. For example, the computing system can use a random seed value to determine the storage locations of each segment within the memory devices 114A-114F. This random seed value can be generated by an NVM circuit (e.g., the NVM circuit 109) of the computing system. In some implementations, the distribution can be performed by allocating unwritten regions of the memory devices using randomly generated values. The computing system can then store each segment of the microcode and protection key in a different code region. In some implementations, padding data can be generated and added to the code regions to ensure that the code regions are populated with data.

The computing system can generate a memory map (e.g., the memory map 106) that can be used to retrieve and reconstruct the microcode and protection key(s). The memory map can include information about the storage locations of each segment, the order in which the segments should be combined, and any padding data that has been added. For example, the memory map can be organized as a table or list, with entries corresponding to the addresses of the code regions within one or more memory devices. The memory map can be encrypted using the random seed value and stored within a memory controller (e.g., the memory controller 104) of the computing system.

When the microcode and protection key need to be retrieved, the computing system can decrypt the memory map using an OTP key, as described herein, to locate the segments within the code regions, and reconstruct the microcode and protection key based on the information in the memory map. In some implementations, the computing system can also update any relevant metadata or expiration criteria associated with the renewed microcode and protection keys. For example, any counter values (e.g., the counter 111, etc.) tracking a number of resets or uses of the microcode can be reset. In some implementations, additional expiration criteria (e.g., expiration timestamps, etc.) can be generated by the computing system (e.g., using predetermined rules or data from the external computing system) or provided by the external computing system. Once renewed, the computing system can execute the microcode with the protection key as described in connection with operation 418 of the method 400 of FIG. 4.

In one aspect of the present disclosure, a computing device is disclosed. The computing device can include a plurality of memory devices and a memory controller. The memory controller can include an encrypted memory map. The memory controller can decrypt the encrypted memory map to generate a decrypted memory map defining memory locations of a plurality of code regions of the plurality of memory devices. The memory controller can retrieve microcode and a protection key using the memory locations of the plurality of code regions. The memory controller can validate the microcode and a protection key. The memory controller can execute the microcode using the protection key.

In another aspect of the present disclosure, a system is disclosed. The system can include one or more circuits. The one or more circuits can receive a request to renew microcode. The one or more circuits can retrieve the microcode and a protection key from an external computing system. The one or more circuits can determine that the microcode and the protection key are valid. The one or more circuits can, responsive to determining that the microcode and the protection key are valid, store the microcode and the protection key in a plurality of code regions of a plurality of memory devices.

In yet another aspect of the present disclosure, a method is disclosed. The method can include decrypting, by a computing device including a plurality of memory devices, an encrypted memory map to generate a decrypted memory map defining memory locations of a plurality of code regions of a plurality of memory devices. The method can include retrieving, by the computing device, microcode and a protection key using the memory locations of the plurality of code regions. The method can include validating, by the computing device, the microcode and a protection key. The method can include executing, by the computing device, the microcode using the protection key.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computing device, comprising:
a plurality of memory devices; and
a memory controller comprising an encrypted memory map, the memory controller configured to:
decrypt the encrypted memory map to generate a decrypted memory map defining memory locations of a plurality of code regions of the plurality of memory devices;
retrieve microcode and a protection key using the memory locations of the plurality of code regions;
validate the microcode and a protection key; and
execute the microcode using the protection key.

2. The computing device of claim 1, wherein the memory controller is further configured to decrypt the encrypted memory map using a key received from an external computing system.

3. The computing device of claim 1, wherein the memory controller is further configured to verify the microcode using the protection key.

4. The computing device of claim 1, wherein the memory controller is further configured to determine that the microcode and the protection key are not expired based on a counter value.

5. The computing device of claim 4, wherein the memory controller is further configured to update the counter value upon executing the microcode using the protection key.

6. The computing device of claim 1, wherein the memory controller is further configured to determine that the microcode and the protection key are not expired based on an expiration timestamp.

7. The computing device of claim 1, wherein the memory controller is further configured to:
receive, from an external computing system, an indication that the microcode and the protection key are to be renewed; and
initiate renewal of the microcode and the protection key in response to the indication.

8. The computing device of claim 1, wherein the protection key has greater than sixty-four thousand bits.

9. The computing device of claim 1, wherein the memory controller is further configured to load the microcode into at least one processor.

10. The computing device of claim 1, wherein the memory controller is further configured to:
receive the microcode and the protection key from an external computing system;
store the microcode and the protection key in the plurality of code regions of the plurality of memory devices; and
generate the encrypted memory map based on the memory locations of the plurality of code regions.

11. A system, comprising:
one or more circuits configured to:
receive a request to renew microcode;
retrieve the microcode and a protection key from an external computing system;
determine that the microcode and the protection key are valid; and
responsive to determining that the microcode and the protection key are valid, store the microcode and the protection key in a plurality of code regions of a plurality of memory devices.

12. The system of claim 11, wherein the one or more circuits are further configured to randomly determine memory locations of the plurality of code regions.

13. The system of claim 11, wherein the one or more circuits are further configured to verify a digital signature of the microcode using a public key stored in read-only memory.

14. The system of claim 11, wherein the one or more circuits are further configured to verify a digital signature of the protection key using a public key stored in read-only memory.

15. The system of claim 11, wherein the one or more circuits are further configured to:
determine that previously stored microcode has expired; and
provide the request to renew the microcode in response to determining that previously stored microcode has expired.

16. The system of claim 11, wherein the one or more circuits are further configured to generate a memory map including memory locations of the plurality of code regions.

17. The system of claim 16, wherein the one or more circuits are further configured to encrypt the memory map using a random seed value stored in a non-volatile memory (NVM) circuit.

18. A method, comprising:
decrypting, by a computing device including a plurality of memory devices, an encrypted memory map to generate a decrypted memory map defining memory locations of a plurality of code regions of a plurality of memory devices;
retrieving, by the computing device, microcode and a protection key using the memory locations of the plurality of code regions;
validating, by the computing device, the microcode and a protection key; and
executing, by the computing device, the microcode using the protection key.

19. The method of claim 18, further comprising decrypting, by the computing device, the encrypted memory map using a key received from an external computing system.

20. The method of claim 18, further comprising determining, by the computing device, that the microcode and the protection key are not expired based on a counter value.
